(19) United States
(12) Patent Application Publication
(10) Pub. No.: US 2022/0137554 A1
(43) Pub. Date: May 5, 2022

(54) IMAGE FORMING APPARATUS

(71) Applicant: Konica Minolta, Inc., Tokyo (JP)

(72) Inventor: Toshihiro WAZUMI, Tokyo (JP)

(21) Appl. No.: 17/511,106

(22) Filed: Oct. 26, 2021

(30) Foreign Application Priority Data
Oct. 29, 2020 (JP) 2020-181195

(51) Int. Cl. G03G 21/20; G06K 15/00

(52) U.S. Cl. CPC G03G 21/206; G06K 15/4065

(57) ABSTRACT

An image forming apparatus includes: a contact portion that is disposed at a position. where the contact portion is contactable with a recording medium; a cooler that cools the recording medium; and a hardware processor that controls a cooling action of the cooler on the recording medium based on information on a temperature of the recording medium.

### BACKGROUND

### Technological Field

The present invention relates to an image forming apparatus.

### Description of the Related Art

There is known an electrophotographic image forming apparatus including a fixer that heats and pressurizes a recording medium on which an image has been formed, whereby the image is fixed to the recording medium. In the fixer, a fixing temperature is controlled so as to be within a predetermined range from a viewpoint of fixability of the image.

Since the recording medium having passed through the fixer is conveyed in a high temperature state, for example, JP 2003-21978 A discloses a configuration in which a cooling device (blower) for cooling the image formed on the recording medium is provided.

In addition, toner as the image formed on the recording medium contains a release agent (wax) from a viewpoint of releasability in the fixer. The release agent exists as a liquid at a high temperature, is solidified by temperature drop, and seeps out to a surface of the fixed image.

Incidentally, in the process of temperature transition, there are a case where the release agent becomes transparent and a case where the release agent becomes cloudy depending on a temperature change amount during transition in a predetermined temperature range. Specifically, in a case where the temperature change amount during the transition in the predetermined temperature range is relatively large, a surface layer containing the release agent becomes transparent, and in a case where the temperature change amount during the transition in the predetermined temperature range is relatively small, the surface layer becomes cloudy.

Since the image forming apparatus is provided with a member that comes into contact with the recording medium (roller, guide, roller, bearing, or the like) in a conveyance path for the recording medium, the recording medium may be deprived of heat by such a member, That is, due to the presence of this member, a temperature state of the recording medium in a width direction may be non-uniform. Therefore, the state of the surface layer of the image may he non-uniform in the width direction, and eventually, gloss unevenness may occur in the image.

### SUMMARY

An object of the present invention is to provide an image forming apparatus capable of preventing the state of a surface layer of an image from being non-uniform in a width direction.

To achieve the abovementioned object, according to an aspect of the present invention, an image forming apparatus reflecting one aspect of the present invention comprises: a contact portion that is disposed at a position where the contact portion is contactable with a recording medium; a cooler that cools the recording medium; and a hardware processor that controls a cooling action of the cooler on the recording medium based on information a temperature of the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus according to an embodiment of the present invention;

FIG. 2 is a diagram illustrating a main part of a control system of the image forming apparatus according to the present embodiment;

FIG. 3A is a side view of a fixer and a conveyance roller;

FIG. 3B is a top view of the fixer and the conveyance roller;

FIG. 4 is a diagram illustrating a temperature change of a sheet at positions m a conveyance direction of the sheet;

FIG. 5 is a diagram illustrating the temperature change of the sheet at positions in a width direction of the sheet;

FIG. 6 is a diagram illustrating the temperature change of the sheet at positions in the conveyance direction of the sheet in a case where a cooling amount of a cooler is adjusted;

FIG. 7 is a diagram illustrating an example of a table in which the cooling amount of the cooler is associated with a color including a plurality of layers and a sheet size or an image area;

FIG. 8 is a flowchart illustrating an operation example of cooling amount adjustment control in the cooler of the image forming apparatus;

FIG. 9 is a side view of the fixer and a plurality of conveyance rollers in an embodiment in which the plurality of conveyance roller is included;

FIG. 10A is a diagram illustrating the temperature change of the sheet at positions in the conveyance direction of the sheet in the embodiment according to FIG. 9;

FIG. 10B is a diagram illustrating the temperature change of the sheet in a case where the cooling amount of the cooler is adjusted in FIG. 10A;

FIG. 11 is a side view of the fixer and lie conveyance rollers in an embodiment in which a plurality of coolers is included;

FIG. 12 is a side view of the fixer and the conveyance rollers in an embodiment in which temperature detectors are included;

FIG. 13 is an example of a table in which the cooling amount in the cooler is associated with an adjustment amount of the cooling amount and the number of toner layers of an image;

FIG. 14 is an example of a table in which the cooling amount in the cooler is associated with the adjustment amount of the cooling amount and the number of toner layers of the image;

FIG. 15A is a side view of the fixer and the conveyance roller in a configuration in which an air blowing direction of the cooler can be changed;

FIG. 15B is a side view of the fixer and tile conveyance roller in the configuration in which the air blowing direction of the cooler can be changed; and

FIG. 16 is a side view of the fixer and the conveyance roller in a configuration in which the conveyance roller is movable.

### DETAILED DESCRIPTION OF EMBODIMENTS

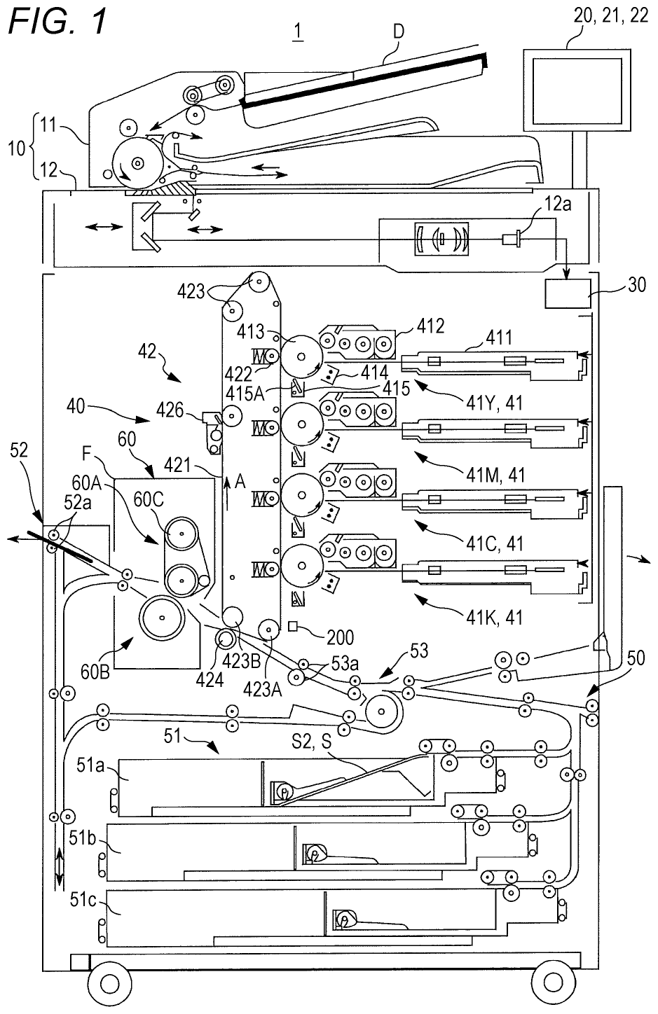

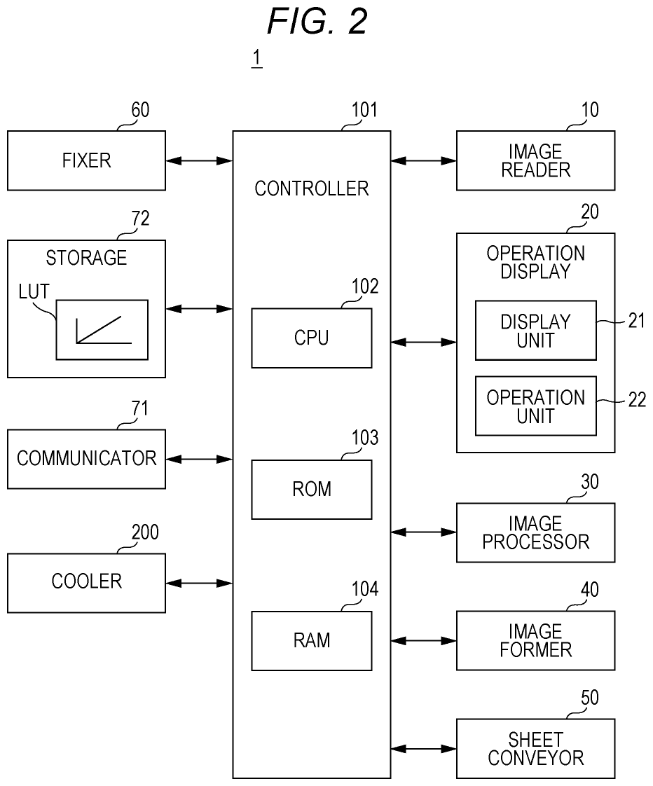

Hereinafter, one or more embodiments of the present invention will be described with reference to the drawings. However, the scope of the invention is not limited to the disclosed embodiments. FIG. 1 is a diagram schematically illustrating an overall configuration of an image forming apparatus 1 according to an embodiment of the present invention. FIG. 2 is a diagram illustrating a main part of a control system of the image forming apparatus 1 according to the present embodiment.

The image forming apparatus 1 illustrated in FIGS. 1 and 2 is an intermediate transfer-type color image forming apparatus using an electrophotographic process technology. That is, the image forming apparatus 1 primarily transfers toner images of respective colors of yellow (Y), magenta (M), cyan (C), and black (K) formed on photoconductor drums 413 to an intermediate transfer belt 421, superimposes the toner images of the four colors on the intermediate transfer belt 421, and then secondarily transfers the toner images to a sheet S (recording medium) to form an image.

In addition, the image forming apparatus 1 employs a tandem system in which the photoconductor drums 413 corresponding to the four colors of YMCK are disposed in series in a traveling direction of the intermediate transfer belt 421, and the toner images of the respective colors are sequentially transferred to the intermediate transfer belt 421 in one procedure.

As illustrated in FIG. 2, the image forming apparatus 1 includes an image reader 10, an operation display 20, an image processor 30, an image former 40, a sheet conveyor 50, a fixer 60. a controller 101, and a cooler 200.

The controller 101 includes a central processing unit (CPU) 102, a read only memory (ROM) 103, a random access memory (RAM) 104, and the like. The CPU 102 reads a program corresponding to processing contents from the ROM 103, develops the program in the RAM 104, and centrally controls an operation of each block of the image forming apparatus 1 in cooperation with the developed program. At this time, various types of data stored in a storage 72 are referred to. The storage 72 includes, for example, a nonvolatile semiconductor memory (so-called flash memory) or a hard disk drive.

The controller 101 transmits and receives various types of data to and from an external device (for example, a personal computer) connected to a communication network such as a local area network (LAN) or a wide area network (WAN) via a communicator 71. For example, the controller 101 receives image data transmitted from the external device, and forms an image on the sheet S based on the image data (input image data). The communicator 71 includes, for example, a communication control card such as a LAN card.

As illustrated in FIG. 1, the image reader 10 includes an automatic document feeding device 11 called an auto document feeder (ADF), a document image scanning device 12 (scanner), and the like.

The automatic document feeding device 11 conveys a document D placed on a document tray by a conveying mechanism and sends the document D to the document image scanning device 12. The automatic document feeding device 11 can continuously read images (including images of both sides) of a large number of documents D placed on the document tray at once.

The document image scanning device 12 optically scans a document conveyed onto a contact glass from the automatic document feeding device 11 or a document placed on the contact glass, and forms an image of reflected light from the document on a light receiving surface of a charge coupled device (CCD) sensor 12a to read a document image. The image reader 10 generates the input image data based on a reading result by the document image scanning device 12. The input image data is subjected to predetermined image processing in the image processor 30.

As illustrated in FIG. 2, the operation display 20 includes, for example, a liquid crystal display (LCD) with a touch panel, and functions as a display unit 21 and an operation unit 22. The display unit 21 displays various operation screens, an image state, an operation status of each function, and the like according to a display control signal input from the controller 101. The operation unit 22 includes various operation keys such as a numeric keypad and a start key, receives various input operations by a user, and outputs an operation signal to the controller 101.

The image processor 30 includes a circuit or the like that performs digital image processing on the input image data according to initial settings or user settings. For example, the image processor 30 performs tone correction based on tone correction data (tone correction table) under the control of the controller 101. The image processor 30 also performs, in addition to the tone correction, various types of correction processing such as color correction and shading correction, compression processing, and the like on the input image data. The image former 40 is controlled based on the image data subjected to such processing.

As illustrated in FIG. 1, the image former 40 includes image forming units 41Y, 41M, 41C, and 41K, an intermediate transfer unit 42, and the like. The image forming units 41Y, 41M, 41C, and 41K form images with respective color toner of a Y component, an M component, a C component, and a K component based on the input image data.

The image forming units 41Y, 41M, 41C, and 41K for the Y component, the M component, the C component, and the K component have similar configurations. For convenience of illustration and description, common elements are denoted by the same reference signs, and in the case of distinguishing the components, Y, M, C, or K is added to a reference sign. In FIG. 1, only elements of the image forming unit 41Y for the Y component are denoted by reference signs, and reference signs of elements of the other image forming units 41M, 41C, and 41K are omitted.

The image forming unit 41 includes an exposure device 411, a developing device 412, the photoconductor drum 413, a charging device 414, a drum cleaning device 415, and the like.

The photoconductor drum 413 is made of, for example, an organic photoconductor in which a photoconductor layer made of a resin containing an organic photoconductor is formed on an outer peripheral surface of a drum-shaped metal substrate.

The controller 101 rotates the photoconductor drum 413 at a constant peripheral speed by controlling a drive current supplied to a drive motor (not illustrated) that rotates the photoconductor drum 413.

The charging device 414 is, for example, an electrostatic charger, and generates corona discharge to uniformly charge a surface of the photoconductor drum 413 having photoconductivity to negative polarity.

The exposure device 411 includes, for example, a semiconductor laser, and irradiates the photoconductor drum 413 with laser light corresponding to an image of each color component. As a result, an electrostatic latent image of each color component is formed on an image region irradiated with the laser light, which is included in the surface of the photoconductor drum 413, due to a potential difference from a background region.

The developing device 412 is a two-component reversal type developing device, and attaches a developer of each color component to the surface of the photoconductor drum 413 to visualize the electrostatic latent image, thereby forming a toner image.

For example, a DC developing bias having the same polarity as a charging polarity of the charging device 414 or a developing bias obtained by superposing a DC voltage having the same polarity as the charging polarity of the charging device 414 on an AC voltage is applied to the developing device 412. As a result, reversal development is perforated in which the toner is attached to the electrostatic latent image formed by the exposure device 411.

The drum cleaning device 415 includes a flat plate-shaped drum cleaning blade 415A or the like that comes into contact with the surface of the photoconductor drum 413 and is made of an elastic body, and removes toner remaining on the surface of the photoconductor drum 413, which has not been transferred to the intermediate transfer belt 421.

The intermediate transfer unit 42 includes the intermediate transfer belt 421. a primary transfer roller 422, a plurality of support rollers 423, a secondary transfer roller 424, a belt cleaning device 426, and the like. The intermediate transfer belt 421 corresponds to an “image carrier” of the present invention.

The intermediate transfer unit 42 includes an endless belt, and is looped around the plurality of support rollers 423. At least one of the plurality of support rollers 423 is a driving roller, and the others are driven rollers. For example, a roller 423A disposed on the downstream side of the primary transfer roller 422 for the K component in the belt traveling direction is preferably the driving roller. This configuration makes it easy to maintain a traveling speed of the belt constant at a primary transfer nip. When the driving roller 423A rotates, the intermediate transfer belt 421 travels at a constant speed in a direction of an arrow A.

The primary transfer roller 422 is disposed on an inner peripheral surface side of the intermediate transfer belt 421 so as to face the photoconductor drum 413 of each color component. The primary transfer roller 422 is brought into pressure contact with the photoconductor drum 413 with the intermediate transfer belt 421 interposed therebetween, thereby forming the primary transfer nip for transferring the toner image from the photoconductor drum 413 to the intermediate transfer belt 421.

The secondary transfer roller 424 is disposed on an outer peripheral surface side of the intermediate transfer belt 421 so as to face a backup roller 423B disposed on the downstream side of the driving roller 423A in the belt traveling direction. The secondary transfer roller 424 is brought into pressure contact whir the backup roller 423B with the intermediate transfer belt 421 interposed therebetween, thereby forming a secondary transfer nip for transferring the toner image from the intermediate transfer belt 421 to the sheet S.

When the intermediate transfer belt 421 passes through the primary transfer nip, the toner images on the photoconductor drums 413 are sequentially superimposed on and primarily transferred to the intermediate transfer belt 421. Specifically, a primary transfer bias is applied to the primary transfer roller 422, and a charge having a polarity opposite to that of the toner is applied to the back surface side of the intermediate transfer belt 421, that is, the side in contact with the primary transfer roller 422, whereby the toner images are electrostatically transferred to the intermediate transfer belt 421.

Thereafter, when the sheet S passes through the secondary transfer nip, the toner images on the intermediate transfer belt 421 are secondarily transferred to the sheet S. Specifically, a secondary transfer bias is applied to the backup roller 423B, and a charge having the same polarity as that of the toner is applied to the front surface side of the sheet S, that is, the side in contact with the intermediate transfer belt 421, whereby the toner images are electrostatically transferred to the sheet 5, and the sheet S is conveyed toward the fixer 60.

The belt cleaning device 426 removes transfer residual toner remaining on a surface of the intermediate transfer belt 421 after the secondary transfer. Note that, instead of the secondary transfer roller 424, a so-called belt-type secondary transfer unit may be employed in which a secondary transfer belt is looped around a plurality of Support rollers including a secondary transfer roller.

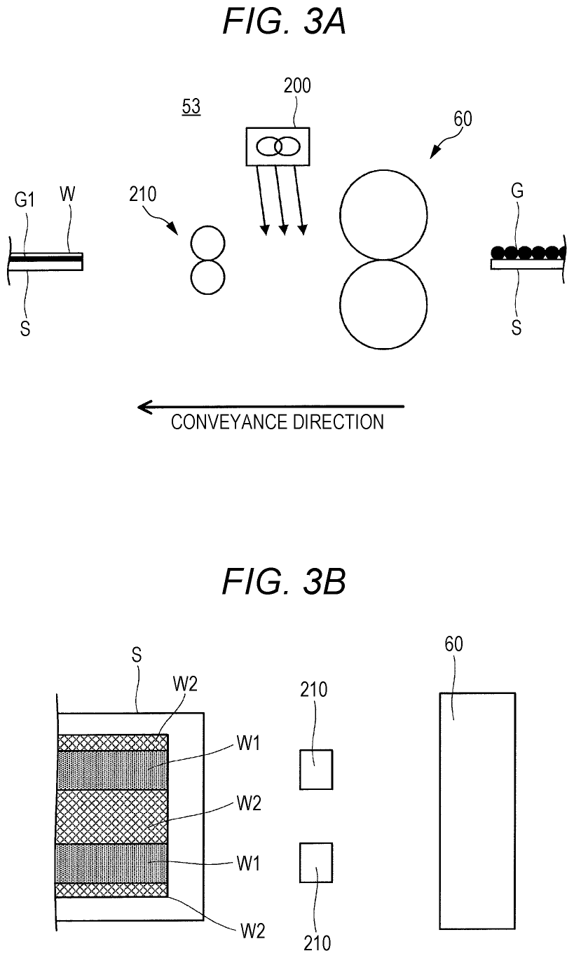

The fixer 60 is disposed on the upstream side of the cooler 200 to he described later in a conveyance direction of the sheet S (see also FIG. 3A). The fixer 60 includes an upper fixer 60A, a lower fixer 60B, a heating source 60C, and the like. The upper fixer 60A includes a fixing surface side member disposed on the side of a fixing surface of the sheet S, that is, a surface on which the toner image is formed, and the lower fixer 60B includes a back surface side support member disposed on the side of a back surface of the sheet S, that is, a surface opposite to the fixing surface. When the back surface side support member is brought into pressure contact with the fixing surface side member, a fixing nip for nipping and conveying the sheet S is formed.

The fixer 60 heats and pressurizes, at the fixing nip, the conveyed sheet S on which the toner image has been secondarily transferred to fix the toner image on the Sheet S. The fixer 60 is disposed as a unit in a fixing device F.

The sheet conveyor 50 includes a sheet feeder 51, a sheet discharger 32, a conveyance path 53, and the like. In three sheet feed tray wilts 51a to 51c included in the sheet feeder 51, sheets S identified based on basis weight, size, or the like are stored for each preset type. The conveyance path 53 includes a plurality of conveyance rollers such as a resist roller pair 53a.

The sheets S stored in the sheet feed tray units 51a to 51c are sent out one by one from the top, and are conveyed to the image former 40 by the conveyance path 53. In the image former 40, the toner images on the intermediate transfer belt 421 are secondarily transferred to one surface of tile sheet S collectively, and a fixing step is performed in the fixer 60. The sheet S on which the image has been formed is discharged to the outside of tile apparatus by the sheet discharger 52 including a sheet discharge roller 52a.

As illustrated in FIG. 3A, the cooler 200 is a fan (blower) for cooling the sheet S conveyed on the conveyance path 53, and is disposed on the downstream side of the fixer 60. The cooler 200 is configured to be able to cool a position in the conveyance path 53, which corresponds to the upstream side of a conveyance roller 210 to be described later, and cools the sheet S by blowing air to the sheet S having passed through the fixer 60.

Furthermore, in the conveyance path 53, the conveyance roller 210 is provided on the downstream side of the cooler 200 in the conveyance direction of the sheet S. The conveyance roller 210 is made of metal, for example, and has two rollers disposed side by side in a width direction of the sheet S, as illustrated in FIG. 3B. The interval between the two rollers included in the conveyance roller 210 is set according to the width of a sheet having a minimum size applicable to the image forming apparatus 1. The conveyance roller 210 corresponds to a “contact portion” of the present invention. Note that FIG. 3B does not illustrate the cooler 200.

The controller 101 controls a cooling action of the cooler 200 on the sheet S based on information on the temperature of the sheet S. Specifically, the controller 101 estimates a temperature change of the sheet S caused by the conveyance roller 210 based on the information on the temperature. The controller 101 adjusts a cooling amount in the cooler 200 based on an estimation result of the temperature change.

The information on the temperature of the sheet S is, for example, information on the type of the sheet S (basis weight, size, grain direction, and thee, like) input to the image forming apparatus 1. This is because, for example, a fixing temperature in the fixer 60 is determined, and thus, the temperature of the sheet S can be experimentally estimated based on the fixing temperature.

Furthermore, the information on the temperature of the sheet S may be, for example, information on at least one of the temperature or the humidity around the image forming apparatus 1. This is because the temperature of the sheet S can be experimentally estimated from the relationship between the fixing temperature and the information on at least one of the temperature or the humidity around the image forming apparatus 1. Note that the information on at least one of the temperature or the humidity around the image forming apparatus 1 is information acquired by a temperature and humidity detector provided in the image forming apparatus 1, a

temperature and humidity detector provided around the image forming apparatus 1, or the like, and the image forming apparatus 1 acquires the information automatically or by manual input by the user.

The temperature change of the sheet S caused by the conveyance roller 210 is a temperature change of the sheet S between before and after the sheet S passes through the conveyance roller 210.

When the sheet S passes through the position of the conveyance roller 210, tile sheet S and the conveyance roller 210 come into contact with each other, whereby the conveyance roller 210 deprives the sheet S of heat, and thus, the temperature of the sheet S becomes lower than that before the contact with the conveyance roller 210.

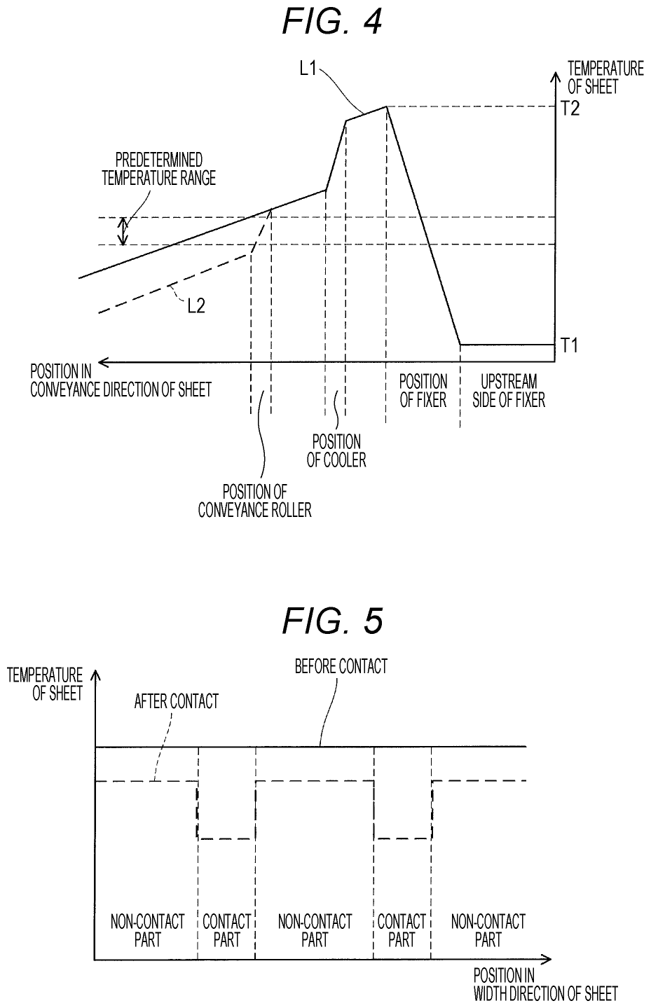

For example, it has been experimentally found that the temperature of the sheet S at the time of passing through the vicinity of the fixer 60 changes as indicated by a solid line L1 illustrated in FIG. 4. More specifically, the temperature of the sheet S is T1 at a position on the upstream side of the fixer 60, but when the sheet S passes through the position of the fixer 60, the sheet S is heated by the fixer 60, whereby the temperature of the sheet S rapidly rises from T1 to T2.

When the sheet S passes through the position of the cooler 200, the sheet S is cooled by the cooler 200 and the temperature decreases. Thereafter, as the sheet S goes toward the downstream side of the fixer 60, the temperature of the sheet S gradually decreases due to heat dissipation. Note that shifting from the right to the left on the horizontal axis in FIG. 4 (the position of the sheet S) indicates that the position of the sheet S shifts from the upstream side to the downstream side in the conveyance direction.

However, if the contact portion that comes into contact with a part of the sheet S being conveyed is present in the conveyance path 53 as in the conveyance roller 210, the temperature of the sheet S rapidly decreases at the position of a contact part where the sheet S comes into contact with the contact portion, as indicated by a broken line L2 illustrated in FIG. 4. That is, a temperature change amount of the sheet S per unit time increases between before and after the position of the contact part.

Here, for example, as in the present embodiment, in a case where the contact portion is the conveyance roller 210 having two roller pairs disposed in the width direction, the temperature of the sheet S is not uniform in the width direction after the sheet S comes into contact with the conveyance roller 210.

Specifically, since the sheet S has a part that comes into contact with the conveyance roller 210 (contact part) and a part that does not come into contact with the conveyance roller 210 (non-contact part) in the width direction, for example, as illustrated in FIG. 5, a temperature distribution of the sheet Sin the width direction is such that the contact part is recessed relative to the non-contact part.

Therefore, a phenomenon occurs in which the temperature change of the sheet S in a part corresponding to the contact part is larger than the temperature change in a part corresponding to the non-contact part between before and after the contact with the conveyance roller 210.

In addition, as illustrated in FIG. 3A, toner G, which is an image formed on the sheet 5, contains a release agent (for example, wax) for peeling the image from the fixer 60. The release agent exists as a liquid at a high temperature, is solidified by temperature drop, and seeps out to a surface of the image. Therefore, the image is obtained in which a surface layer W containing the release agent and a toner layer G1 formed of the toner G are stacked.

In the process of temperature transition in the vicinity of the fixer 60, there are a case where the release agent becomes transparent and a case where the release agent becomes cloudy depending on the temperature change amount during transition in a predetermined temperature range. The predetermined temperature range is, for example, a range of 50° C. to 90° C., and is a crystallization temperature in a case where the release agent is crystalline, and a temperature range from a melting point to a glass transition point in a case where the release agent is non-crystalline.

In a case where the temperature change amount during the transition in the predetermined temperature range is relatively large, the release agent (surface layer) becomes transparent, and in a case where the temperature change amount during the transition in the predetermined temperature range is relatively small, the release agent (surface layer) becomes cloudy.

As described above, in the case where the sheet S having passed through the fixer 60 passes through the position of the conveyance roller 210, the temperature change amount in the contact part where the sheet S comes into contact with the conveyance roller 210 is larger than that in the non-contact part. Therefore, when the temperature of the sheet S at the time of passing through the vicinity of the conveyance roller 210 is close to the predetermined temperature range, a part where the release agent becomes transparent and a part where the release agent becomes cloudy may appear in the image.

For example, as illustrated in FIG. 3B, in the contact part where the sheet S comes into contact with the conveyance roller 210, in a case where the temperature change amount from the temperature immediately before the contact to the temperature immediately after the contact is large enough to exceed the predetermined temperature range, the release agent in the contact part becomes transparent (part W1 in FIG. 3B).

On the other hand, in the non-contact part where the sheet S does not come into contact with the conveyance roller 210, the temperature change amount front the temperature immediately before the contact to the temperature immediately after the contact remains gentle, and thus, the release agent in the non-contact part becomes cloudy (part W2 in FIG. 3B).

Therefore, in the image formed on the sheet S, the state of the surface layer W is different between the part that has come into contact with the conveyance roller 210 and the part that has not come into contact with the conveyance roller 210. That is, the state of the surface layer W of the sheet S is non-uniform in the width direction, and eventually, gloss unevenness (streak) occurs in the image.

In the present embodiment, the controller 101 estimates the above-described temperature change in the contact part based on the information on the temperature of the sheet S. The estimated temperature change is, for example, a temperature change amount experimentally calculated in consideration of the type oh the sheet S (basis weight, size, grain direction, and the like), the image forming condition (conveyance speed of the sheet S, fixing temperature, image data, and the like), the material of the conveyance roller 210, and the like.

The controller 101 adjusts the cooling amount in the cooler 200 according to the relationship between a range of temperature that transitions within a predetermined time and the predetermined temperature range based on the estimation result. More specifically, in a case where the range of temperature that transitions within the predetermined time exceeds the predetermined temperature range, the controller 101 changes the cooling amount in the cooler 200 from a set cooling amount. in the present embodiment, the cooling amount in the cooler 200 is adjusted to zero.

The predetermined time is, for example, a time from when the leading end of the sheet S reaches the conveyance roller 210 until when the trailing edge of the sheet S passes through the conveyance roller 210, and is a time that can he set by the conveyance speed or the like.

The set cooling amount is, for example, a cooling amount set in advance at the time of image formation. In the present embodiment, for example, a maximum cooling amount in the cooler 200 is set as the set cooling amount.

In a case where the range of temperature that transitions within the predetermined time (for example, a time corresponding to a range corresponding to the position of the conveyance roller in FIG. 4) exceeds the predetermined temperature range, the surface layer becomes transparent. Therefore, since the state of the surface layer is different from the cloudy state of the surface layer in the non-contact part, gloss unevenness is likely to occur.

Therefore, in this case, for example, the cooling amount is adjusted such that the cooling amount in the cooler 200 is smaller than the set cooling amount (maximum cooling amount), whereby it is possible to prevent the range of temperature that transitions within the predetermined time from exceeding the predetermined temperature range.

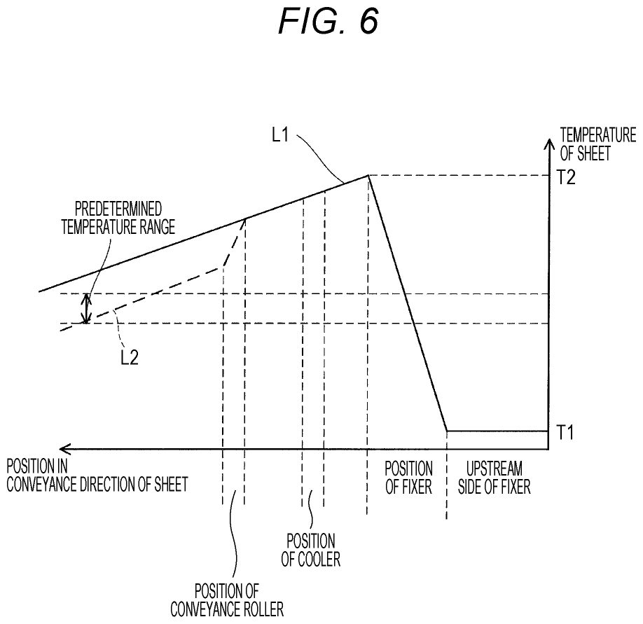

For example, in the example illustrated in FIG. 6, the temperature change amount at the position of the cooler 200 is smaller, and thus, the range of temperature that transitions within the predetermined time (the temperature of the sheet S when the sheet S passes through the position of the conveyance roller 210) is a temperature range higher than the predetermined temperature range. With this adjustment, it is possible to make the temperature change gentle (see a broken line L2) when the temperature of the sheet S transitions in the predetermined temperature range.

As a result, it is possible to prevent the state of the surface layer W from being different between the part that has come into contact with the conveyance roller 210 and the part that has not come into contact with the conveyance roller 210, and eventually, it is possible to prevent the occurrence of gloss unevenness in the image.

In a case where the range of temperature that transitions within the predetermined time does not exceed the predetermined temperature range, the controller 101 does not change the cooling amount in the cooler 200 front the set cooling amount.

In this case, it is possible to maintain a desired cooling action in the cooler 200.

Note that, even in the case where the range of temperature that transitions within the predetermined time does not exceed the predetermined temperature range, the controller 101 may change the cooling amount in the cooler 200 from the set cooling amount, for example, in a case where the range of temperature that transitions within the predetermined time reaches most of the predetermined temperature range. The degree of reach of this range of temperature to the predetermined temperature range can be arbitrarily determined.

In addition, the controller 101 may adjust the cooling amount in the cooler 200 based on information on the image data formed on the sheet S in addition to the information on the temperature of the sheet S.

For example, in the case of a single-layer solid image including a solid image of one color such as only the Y color, only the M color, only the C color, or only the K color, the amount of release agent is small due to a small amount of toner, and thus, even if gloss unevenness occurs, it is difficult for the user to visually recognize the gloss unevenness.

Therefore, in a case where the image data relates to a single-layer solid image, the controller 101 does not adjust the cooling amount in the cooler 200.

In addition, in the case of a multi-layer solid image including a solid image using two or more colors among the Y color, the M color, the C color, and the K color (for example, red, blue, or green), the amount of release agent also increases as the amount of toner increases, and thus, when gloss unevenness occurs, it is easy for the user to visually recognize the gloss unevenness.

Therefore, in a case where the image data relates to a multi-layer solid image, the controller 101 adjusts the cooling amount in the cooler 200.

This adjustment makes it easy to prevent the occurrence of gloss unevenness.

In addition, even in the case of a multi-layer solid image, when an image area is small, the amount of toner is small, and even when gloss unevenness occurs, it may be difficult for the user to visually recognize the gloss unevenness. For example, for an image formed on a sheet having a small sheet size such as a postcard size or an image having an image area of 40 cm² or less, even if gloss unevenness occurs, the gloss unevenness is less conspicuous because the image size is small.

Therefore, in the case where the image data is a multi-layer solid image, the controller 101 may adjust the cooling amount in the cooler 200 according to the image size, The image size may be determined based on the sheet size or the image area.

For example, in a case where the sheet size is the postcard size or in a case where the image area is 40 cm² or less, the controller 101 does not adjust the cooling amount in the cooler 200. In addition, in a case where the sheet size is an A4S size or more, or in a case where the image area is 60 cm² or more, the controller 101 adjusts the cooling amount in the cooler 200.

In this manner, in a case where the gloss unevenness is not conspicuous although the image data is a multi-layer solid image, it is possible to secure the cooling action in the cooler 200 without adjusting the cooling amount in the cooler 200, and in a case where the gloss unevenness is conspicuous, it is possible to adjust the cooling amount at the cooler 200, thereby preventing the occurrence of gloss unevenness.

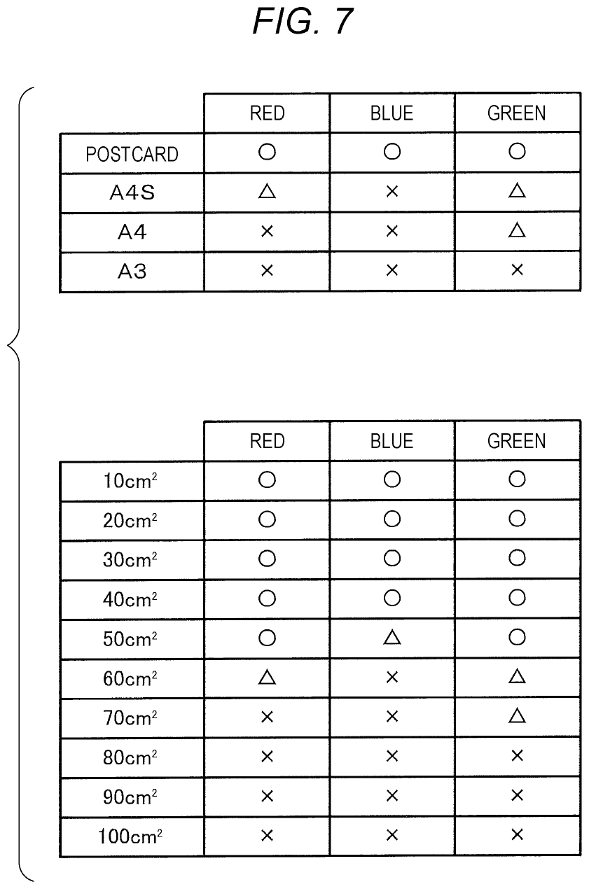

Furthermore, for adjusting the cooling amount, as illustrated in FIG. 7, a table in which the cooling amount in the cooler 200 is associated with the color and the sheet size or the image area may be referred to.

The upper table FIG. 7 is a table in which the cooling amount in the cooler 200 is associated with the color and the sheet size. The lower table in FIG. 7 is a table in which the cooling amount in the cooler 200 is associated with the color and the image area. In FIG. 7, “∘” indicates that the gloss unevenness is less conspicuous, “Δ” indicates that the gloss unevenness is slightly conspicuous, and “x” indicates that the gloss unevenness is conspicuous. These tables are stored in, for example, the storage 72 or the like.

In other words, in FIG. 7, “∘” indicates that the cooling amount in the cooler 200 is not adjusted, and “Δ” and “x” indicate that the cooling amount in tile cooler 200 is adjusted.

As a result, it is possible to easily adjust the cooling amount in the cooler 200 by referring to the table.

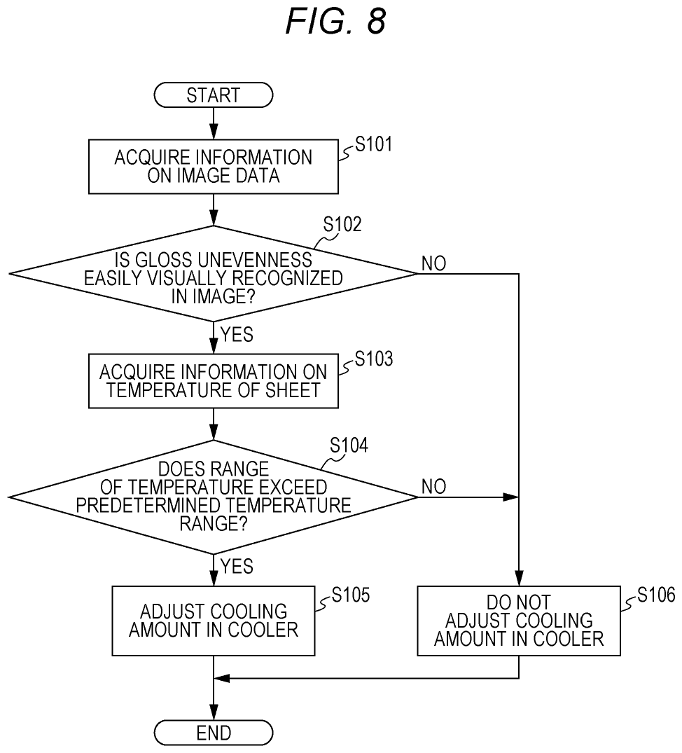

An operation example of cooling amount adjustment control in the cooler 200 of the image forming apparatus 1 configured as described above will be described. FIG. 8 is a flowchart illustrating the operation example of the cooling amount adjustment control in the cooler 200 of the image forming apparatus 1. The processing in FIG. 8 is appropriately executed, for example, when the image forming apparatus 1 receives a print job execution command.

As illustrated in FIG. 8, the controller 101 acquires the information on the image data (step S101). Next, the controller 101 determines whether the image according to the image data is an image in winch the gloss unevenness is easily visually recognized (step S102).

As a result of the determination, in a case where the image according to the image data is an image in which the gloss unevenness is difficult to visually recognize (NO at Step S102), the processing proceeds to step S106. On the other hand, in a case where the image according to the image data is an image in which the gloss unevenness is easily visually recognized (YES in step S102), the controller 101 acquires the information on the temperature of the sheet S (step S103), and determines whether the range of temperature that transitions within the predetermined time exceeds the predetermined temperature range (step S104).

As a result of the determination, in a case where the range of temperature exceeds the predetermined temperature range (YES in step S104), the controller 101 adjusts the cooling amount in the cooler 200 (step S105). On the other hand, in a case where the range of temperature does not exceed the predetermined temperature range (NO in Step S104), the controller 101 does not adjust the cooling amount in the cooler 200 (step S106). After step S105 or step S106, this control ends.

Note that, in the above-described flowchart, steps S101 and S102 and steps S103 and S104 are combined, but the present invention is not limited thereto, and a flowchart including only one set of steps S101 and S102 or steps S103 and S104 may be used.

According to the present embodiment configured as described above, the cooling amount in the cooler 200 is adjusted, whereby it is possible to prevent the state of the surface layer of the image from being non-uniform in the width direction, and eventually, it is possible to prevent the occurrence of gloss unevenness in the image.

Furthermore, the temperature change of the sheet S caused by the conveyance roller 210 is estimated based on the information on the temperature of the sheet S, and the cooling amount in the cooler 200 is adjusted based on the estimation result. As a result, it is possible to accurately maintain the uniformity of the state of the surface layer.

In addition, the conveyance roller 210 is made of metal, and thus easily deprives the sheet S of heat. Eventually, the temperature of the sheet S easily decreases, and the temperature state of the sheet S tends to be non-uniform in the width direction.

In the present embodiment, the cooling amount in the cooler 200 can be adjusted, and thus the state of the surface layer of the image on the sheet S can be made uniform even in a configuration in which the temperature state of the sheet S tends to be non-uniform in the width direction.

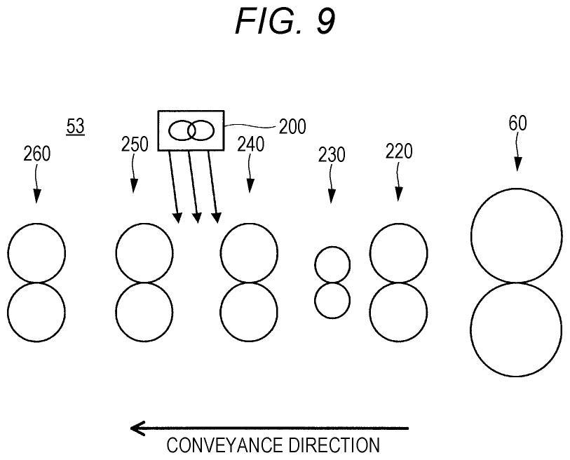

Note that, in the above embodiment, only one conveyance roller 210 is provided, but the present invention is not limited thereto, and for example, as illustrated in FIG. 9, a plurality of conveyance rollers may be provided.

In this configuration, a first conveyance roller 220, a second conveyance roller 230, a third conveyance roller 240, a fourth conveyance roller 250, and a fifth conveyance roller 260 are provided in this order in the conveyance direction on the downstream side of the fixer 60 in the conveyance path 53.

Each of the first conveyance roller 220, the second conveyance roller 230, the third conveyance roller 240, the fourth conveyance roller 250, and the fifth conveyance roller 260 is a roller pair including an upper roller and a lower roller.

Similarly to the above-described conveyance roller 210, the second conveyance roller 230 has a configuration in which two rollers are disposed in the width direction. Each of the first conveyance roller 220, the third conveyance roller 240, the fourth conveyance roller 250, and the fifth conveyance roller 260 is a roller longer than the width of the sheet S in the width direction.

The cooler 200 is disposed at a position corresponding to a space between the third conveyance roller 240 and the fourth conveyance roller 250 so as to be capable of blowing air.

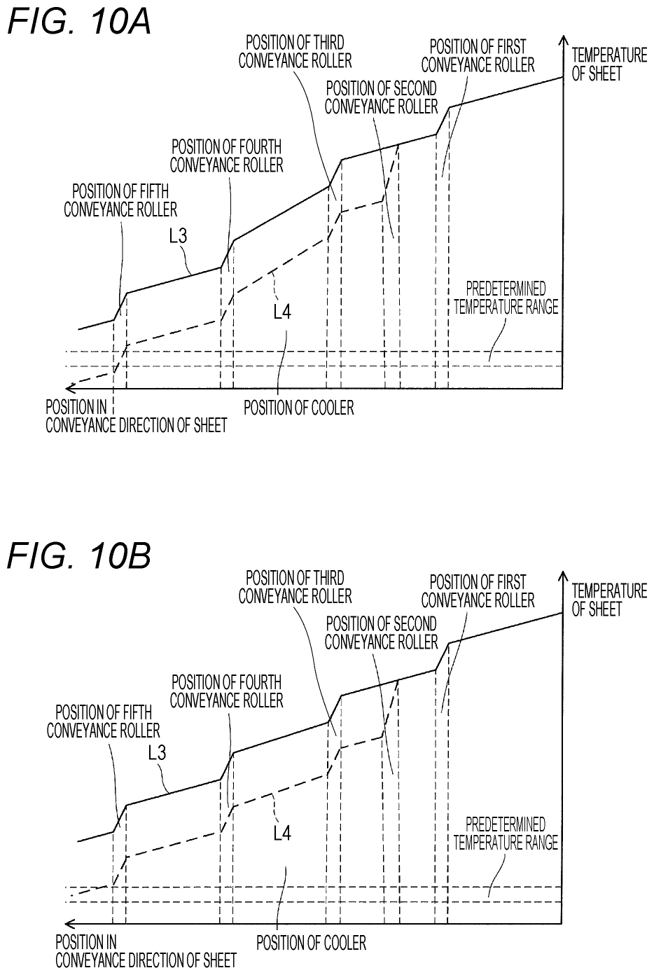

In this configuration, the temperature of the sheet S rapidly decreases in a contact part where the sheet S comes into contact with each roller as illustrated in FIG. 10A, and thus decreases stepwise toward the downstream side in the conveyance direction (see a solid line L3 and a broken line L4).

Specifically, at the position of the second conveyance miter 230, the sheet S has a contact part where the sheet S comes into contact with the second conveyance roller 230 and a non-contact part where the sheet S does not come into contact with the second conveyance roller 230, and thus, the temperature distribution is such that the temperature of a part corresponding to the contact part (the broken line L4) is lower at the position of the second conveyance roller 230 than the temperature of a part corresponding to the non-contact pan (the solid line L3).

At the position of the cooler 200 (the position corresponding to the space between the third conveyance roller 240 and the fourth conveyance roller 250), the temperature change has a relatively steep gradient due to the cooling action of the cooler 200.

Note that, at the positions of the first conveyance roller 220, the third conveyance roller 240, the fourth conveyance roller 250, and the fifth conveyance roller 260, the entire sheet S in the width direction comes into contact with each roller, and thus, the temperatures of the pans corresponding to the contact part and the non-contact part uniformly decrease at the position of each roller.

Therefore, there is a difference in the temperature distribution between the contact part where the sheet S comes into contact with the second conveyance roller 230 (see the broken line L4) and the non-contact part where the sheet S does not come into contact with the second conveyance roller 230 (see the solid line L3), and thus, gloss unevenness may occur, for example, in a case where the temperature of the part corresponding to the contact part overlaps the predetermined temperature range at a position where the sheet S comes into contact with any roller.

In such a case, the controller 101 changes the cooling amount in the cooler 200 from the set cooling amount. As a result, as illustrated in FIG. 10B, the cooling action in the cooler 200 is reduced, and the gradient of the temperature change at the position of the cooler 200 is gender than that of the temperature change in FIG. 10A.

As a result, a part of the broken line L4 in FIG. 10A, which has a large temperature change and overlaps the predetermined temperature range, can be kept away from the predetermined temperature range, so that the state of the surface layer of the image can be made uniform in the width direction, and eventually, it is possible to prevent the occurrence of gloss unevenness.

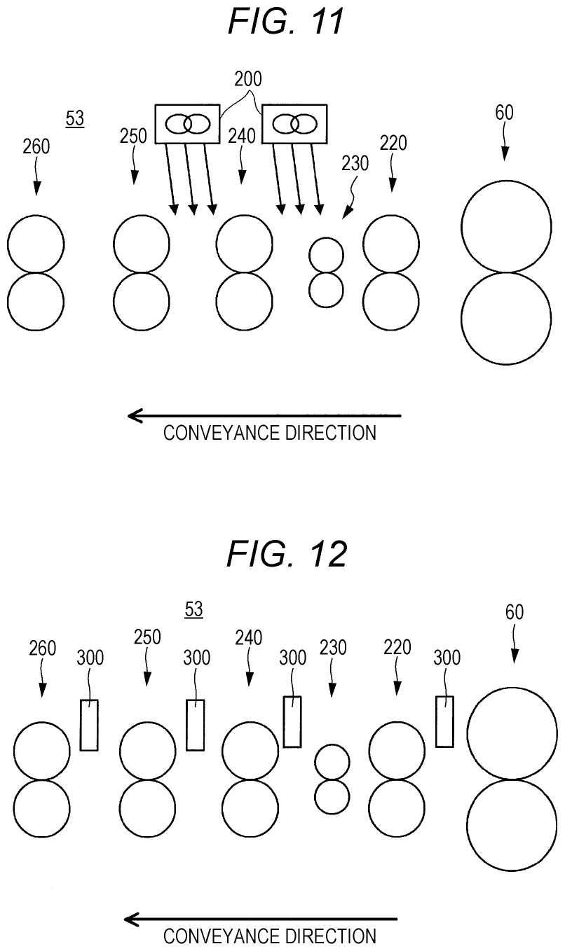

In addition, in the above embodiments, as illustrated in FIG. 11, a plurality of coolers 200 may be provided. In the configuration illustrated in FIG. 11, the plurality of conveyance rollers is provided similarly to the configuration illustrated in FIG. 9.

In the configuration illustrated in FIG. 11, a cooler 200 corresponding to a space between the second conveyance roller 230 and the third conveyance roller 240, and a cooler 200 corresponding to a space between the third conveyance roller 240 and the fourth conveyance roller 250 are provided.

In this configuration, the controller 101 controls the cooling action of each of the plurality of coolers 200. This configuration makes it easy to secure a desired cooling amount.

Furthermore, in the above embodiments, as illustrated in FIG. 12, temperature detectors 300 may be provided. In the configuration illustrated in FIG. 12, the plurality of conveyance rollers is provided similarly to the configuration illustrated in FIG. 9. In FIG. 12, the cooler is not illustrated. Note that a temperature detector may be provided in the configuration illustrated in FIG. 3A or the like.

The temperature detectors 300 are provided in the conveyance path for the sheet S and detect the temperature of the sheet S. One of the temperature detectors 300 is provided in front (on the upstream side in the conveyance direction) of each of the first conveyance roller 220, the third conveyance roller 240, the fourth conveyance roller 250, and the fifth conveyance roller 260.

The controller 101 controls the cooling action of the cooler 200 based on information on detection results of the temperature detectors 300.

For example, in a case where the part reaching the predetermined temperature range among the parts where the temperature rapidly changes is a part corresponding to the fifth conveyance roller 260, the controller 101 changes the cooling amount in the cooler 200 from the set cooling amount.

In this manner, the cooling amount in the cooler 200 is made smaller (see, for example, FIG. 10B), and thus, it is possible to prevent the range of temperature that transitions within the predetermined time from exceeding the predetermined temperature range. As a result, even in a case where there is a difference in the temperature distribution because the sheet S has the contact part where the sheet S comes into contact with the second conveyance roller 230 and the non-contact part where the sheet S does not come into contact with the second conveyance roller 230, the stale of the surface layer can be made uniform, and eventually, it is possible to prevent the occurrence of gloss unevenness.

Furthermore, since the temperature of the sheet can be directly measured, the cooling amount adjustment control in the cooler 200 can be accurately performed.

In addition, in the above embodiments, the cooling action of the cooler 200 is controlled based on the information on the temperature of the sheet and the information on the image data, but the present invention is not limited thereto, and the cooling action of the cooler 200 may be controlled based on read information of the image formed on the sheet S.

In this manner, the user can check the presence or absence of gloss unevenness in the image formed on the sheet S, and then feed back the checked information to control the cooling action of the cooler 200, whereby reliable cooling amount adjustment control can be performed.

Furthermore, in the above embodiments, the cooling amount is set to zero when the cooling amount is adjusted, but the degree of the cooling amount may be finely adjusted.

If the sheet S is not sufficiently cooled by the cooler 200, the toner in the image is discharged in a melted state, and thus, tacking occurs, which is a phenomenon in which when a plurality of sheets S overlaps each other in a discharge tray, the toner of the sheets S adhere to each other.

Therefore, in a case where the adjusted cooling amount is set to zero (the cooler 200 is in the OFF state) when the cooling amount of the cooler 200 is adjusted, there is a possibility that the toner (image) cannot be sufficiently cooled and the above-described tacking cannot be avoided.

For example, in a case where an image formed of toner stacked in a plurality of layers is formed on the sheet S, the amount of toner increases as a whole, and the sheet S is likely to be discharged in a state where the loner is melted. Therefore, it is necessary to sufficiently cool time sheet S by the cooler 200.

In this case, tile controller 101 sets the cooling amount in the cooler 200 to, for example, a cooling amount of about 80% of the set cooling amount. In other words, time controller 101 adjusts the cooling amount of the cooler 200 according to the degree of occurrence of tacking (the amount of toner included in the image formed on the sheet S).

Thus, the cooling amount adjustment control can be performed in consideration of the tacking.

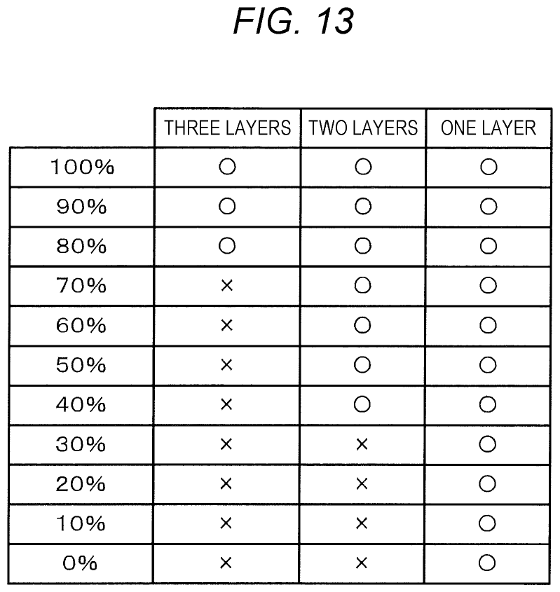

Furthermore, as illustrated in FIG. 13, for adjusting tile cooling amount in the cooler 200, a table in which the occurrence of tacking is associated with an adjustment amount of the cooling amount and the number of toner layers of the image may be referred to.

The table in FIG. 13 is a table in which the cooling amount in the cooler 200 is associated with the adjustment amount of the cooling amount and the number of toner layers of time image. In FIG. 13, “∘” indicates that lacking does not occur, and “x” indicates that the tacking is likely to occur. This table is stored in, for example, the storage 72 or the like.

For example, in a case where the number of toner layers is three, tacking does not occur when the cooling amount in the cooler 200 is in a range of 80% to 100%, and thus, in the case where the number of toner layers is three, for example, the controller 101 sets the cooling amount in the cooler 200 to 80%. Note that 100% in FIG. 13 and the like indicates the set cooling amount.

In addition, in a case where the number of toner layers is two, tacking does not occur when the cooling amount in the cooler 200 is in a range of 40% to 100%, and thus, in the case where the number of toner layers is two, for example, the controller 101 sets the cooling amount in the cooler 200 to 40%.

In addition, in a case where the number of toner layers is one, tacking does not occur when the cooling amount in the cooler 200 is in a range of 0% to 100%, and thus, in the case where the number of toner layers is one, for example, the controller 101 sets the cooling amount in the cooler 200 to 0%.

In this manner, referring to the table makes it possible to easily adjust the cooling amount to such a cooling amount that the occurrence of tacking is prevented. In addition, the cooling amount in the table (section of “∘”) can be appropriately selected based on the relationship between the range of temperature that transitions within the predetermined time and the predetermined temperature range.

Incidentally, in a case where the image forming apparatus 1 performs printing moderately, the inside of the apparatus is warmed up sufficiently. However, in a case where the image forming apparatus 1 is left for a while without performing printing or after the image forming apparatus 1 is turned on, an internal temperature of the image forming apparatus 1 decreases from the temperature in the warmed state (warm temperature), and thus, the temperature of the sheet S may decrease and tacking may not occur even if the sheet S is not cooled by the cooler 200.

Therefore, in a case where the internal temperature of the image forming apparatus 1 has not reached the warm temperature, the controller 101 may adjust the cooling amount in the cooler 200 to be different from a cooling amount in a case where the internal temperature has reached the warm temperature.

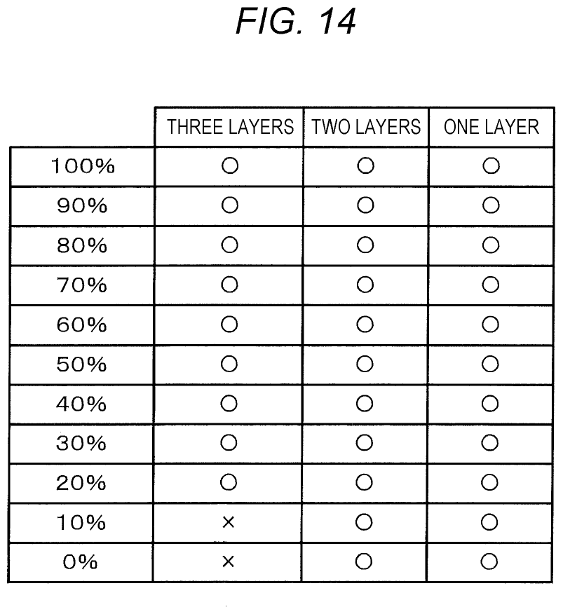

For example, in a case where the. internal temperature of the image forming apparatus 1 has not reached the warm temperature, the controller 101 adjusts the cooling amount in the cooler 200 using the table illustrated in FIG. 14 instead of the table illustrated in FIG. 13.

In this case, for example, in a case where the number of toner layers is three, tacking does not occur when the cooling amount in the cooler 200 is in a range of 20% to 100%, and thus, in the case where the (umber of toner layers is three, the controller 101 sets the cooling amount in the cooler 200 to 20%.

In addition, in a case where the number of toner layers is two or one, tacking does not occur when the cooling amount in the cooler 200 is in a range of 0% to 100%, and thus, in the case where the number of toner layers is two, for example, the controller 101 sets the cooling amount in the cooler 200 to 0%.

As a result, it is possible to prevent the cooler 200 front cooling the sheet S excessively.

In addition, when the conveyance roller 210 continues to convey the heated sheet S after the internal temperature of the image forming apparatus 1 has reached the warm temperature, the temperature of the conveyance roller 210 increases. As the temperature of the conveyance roller 210 increases, the temperature of the sheet S does not decrease even when the sheet S passes through the position of the conveyance roller 210, and for example, the range of temperature that transitions within the predetermined time may not exceed the predetermined temperature range.

In this case, if the cooling amount in the cooler 200 is made smaller than the set cooling amount, the above-described problem of tacking or the like may occur. Therefore, the controller 101 may stop the adjustment of the cooling amount in the cooler 200 according to the temperature of the conveyance roller 210.

The temperature of the conveyance roller 210 may be detected, for example, by a temperature detector provided in the vicinity of the conveyance roller 210. In this manner, the adjustment of the cooling amount in the cooler 200 is stopped based on the temperature of the conveyance roller 210, whereby it is possible to accurately prevent the occurrence of tacking.

Furthermore, the controller 101 may stop the adjustment of the cooling amount in the cooler 200 according to the internal temperature of the image forming apparatus 1 based on information of a temperature detector or the like provided in the image forming apparatus 1.

In this manner, it is possible to prevent the occurrence of tacking without providing the temperature detector for detecting the temperature of the conveyance roller 210.

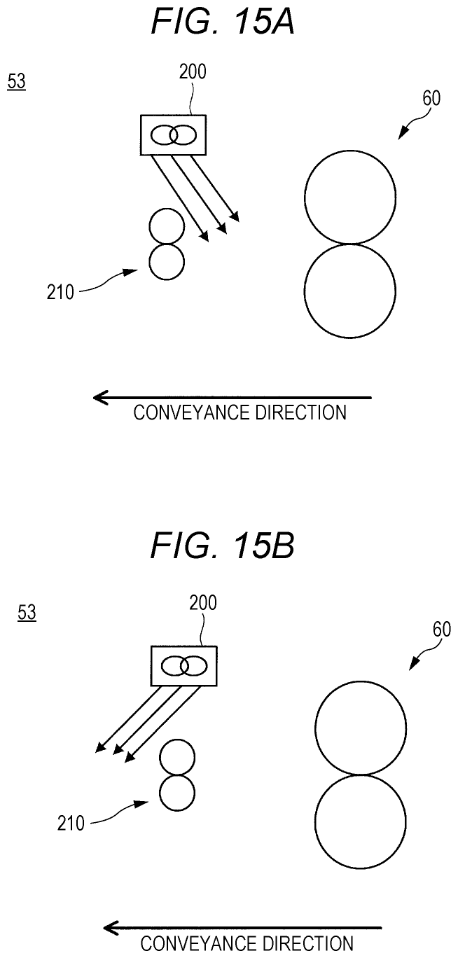

In addition, in the above embodiments, the cooler 200 is configured to be able to blow air to the position corresponding to the upstream side of the conveyance roller 210, but the present invention is not limited thereto. For example, as illustrated in FIGS. 15A and 15B, the cooler 200 may be configured to be able to blow air toward either an upstream position (see FIG. 15A) on the upstream side of the conveyance roller 210 in the conveyance direction of the sheet S or a downstream position (see FIG. 15B) on the downstream side of the conveyance roller 210 in the conveyance direction of the sheet S.

In this case, the controller 101 selects an air blowing direction of the cooler 200 based on the information on the temperature of the sheet S. For example, in a case where the above-described problem of tacking cannot be solved although the cooling amount in the cooler 200 is adjusted so that the problem of gloss unevenness can be solved, the controller 101 selects the air blowing direction of the cooler 200 so as to blow air to the downstream position (see FIG. 15B).

In this manner, it is possible to prevent the occurrence of tacking caused by a decrease in the cooling amount in the cooler 200.

Furthermore, in the above embodiments, the temperature of the sheet S is adjusted by the cooling action of the cooler 200, but the present invention is not limited thereto. For example, for adjusting the temperature of the sheet S, the cooling amount adjustment control of the cooler 200 may be combined with movement control of the conveyance roller 210 capable of moving between a first position and a second position.

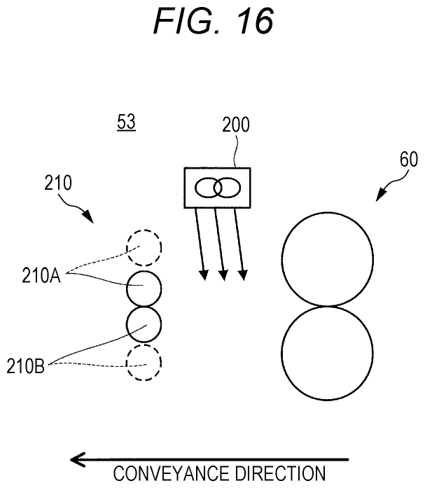

For example, as illustrated in FIG. 16, the first position is a position where an upper roller 210A and a lower roller 210B constituting the conveyance roller 210 come into contact with each other (see a solid line). In a case where the conveyance roller 210 is located at the first position, the sheet S passes through a contact part (nip part) between the upper roller 210A and the lower roller 210B.

The second position is a position where the upper roller 210A and the lower roller 210B are separated from each other (see a broken line). In a case where the conveyance roller 210 is located at the second position, the upper roller 210A is located at a position separated above the conveyed sheet S, and the lower roller 210B is located at a position separated below the conveyed sheet S.

That is, in a case where the conveyance roller 210 is configured to be movable between the first position and the second position, and the conveyance roller 210 is located at the second position, the sheet S does not come into contact with the conveyance roller 210 at a position corresponding to the conveyance roller 210, and thus, the temperature of the sheet S is substantially uniform in the width direction.

The movement control of the conveyance roller 210 is required, for example, in a case where tacking occurs when the cooling amount in the cooler 200 is adjusted. In such a case, the conveyance roller 210 is moved from the first position to the second position, whereby it is possible to prevent the state of the surface layer of the image from being non-uniform in the width direction.

Furthermore, in the above embodiments, when the cooling amount in the cooler 200 is adjusted, the cooling amount is made smaller than the set cooling amount, but the present invention is not limited thereto, and for example, the cooling amount may be made larger than the set cooling amount.

In addition, in the above embodiments, the conveyance roller is exemplified as the contact portion, but the present invention is not limited thereto. For example, the contact portion may be any member such as a guide member, a roller, or a bearing as long as the member can come into contact with the sheet.

Furthermore, the above embodiments, the contact portion (conveyance roller) is made of metal, but the present invention is not limited thereto, and may be made of a material other than metal.

In addition, in the above embodiments, the toner contains the release agent, but the present invention not limited thereto, and the toner may contain another substance that can be the surface layer of the image.

Furthermore, the cooling action of the cooler may be controlled based on information on the temperature of the sheet, which is different from the information on the temperature of the sheet exemplified above. Furthermore, the pieces of the information on the temperature of the sheet exemplified above may be appropriately combined.

Although embodiments oh the present invention have been described and illustrated in detail, the disclosed embodiments are made for proposes of illustration and example only and not limitation. That is, the present invention can be carried out in various forms without departing from its gist or its main features. The scope of the present invention should be interpreted by terms of the appended claims.

What is claimed. is:

1. An image forming apparatus comprising:
a contact portion that is disposed at a position where the contact portion is contactable with a recording medium;
a cooler that cools the recording medium; and
a hardware processor that controls a cooling action of the cooler on the recording medium based on information on a temperature of the recording medium.

2. The image forming apparatus according to claim 1, wherein
the hardware processor
estimates a temperature change of the recording medium based on the information on the temperature, the temperature change being caused by the contact portion, and
adjusts a cooling amount in the cooler based on an estimation result of the temperature change.

3. The image forming apparatus according to claim 2, wherein
the hardware processor adjusts the cooling amount in the cooler based on a relationship between a range of temperature that transitions within a predetermined time and a predetermined temperature range, the relationship being based on the estimation result.

4. The image forming apparatus according to claim 3, wherein
the hardware processor changes the cooling amount in the cooler from a set cooling amount in a case where the range of temperature exceeds the predetermined temperature range.

5. The image forming apparatus according to claim 1, further comprising
a temperature detector that detects the temperature of the recording medium, wherein
the hardware processor controls the cooling action of the cooler based on information on a detection result of the temperature detector.

6. The image forming apparatus according to claim 1, wherein
the hardware processor controls the cooling action of the cooler based on information on time recording medium, the information having been input to the image forming apparatus.

7. The image forming apparatus according to claim 1, wherein
the hardware processor controls the cooling action of the cooler based on information on at least one of a temperature or a humidity around the image forming apparatus.

8. The image forming apparatus according to claim 1, wherein
the hardware processor controls the cooling action of the cooler based on information on image data formed o f the recording medium.

9. The image forming apparatus according to claim 1, wherein
the hardware processor controls the cooling action of the cooler based on read information of an image formed on the recording medium.

10. The image forming apparatus according to claim 1, wherein
the cooler is a blower capable of blowing air to the recording medium.

11. The image forming apparatus according to claim 10, wherein
the contact portion is contactable with the conveyed recording medium,
the cooler is capable of blowing air toward either an upstream position on an upstream side of the contact portion in a conveyance direction of the recording medium or a downstream position on a downstream side of the contact portion in the conveyance direction of the recording medium, and
the hardware processor selects an air blowing direction of the cooler based on the information on the temperature.

12. The image forming apparatus according to claim 1, wherein
the hardware processor stops control of the cooling action in the cooler according to an internal temperature of the image forming apparatus.

13. The image forming apparatus according to claim 1, wherein
the hardware processor stops control of the cooling action in the cooler according to a temperature of the contact portion.

14. The image forming apparatus according to claim 1, wherein
a plurality of the coolers is provided, and
the hardware processor controls a cooling action of each of the plurality of coolers.

15. The image forming apparatus according to claim 1, wherein
the contact portion is provided at a position where the contact portion is capable of coming into contact with a part of the recording medium in a conveyance path where the recording medium is conveyed, and
the cooler is capable of cooling a position corresponding to an upstream side of the contact portion in the conveyance path.

16. The image forming apparatus according to claim 15, further comprising
a fixer that is disposed on an upstream side of the contact portion and the cooler in a conveyance direction of the recording medium, and heats and fixes an image on the recording medium.

17. The image forming apparatus according to claim 16, wherein
a surface layer of the image formed on the recording medium includes a release agent that peels the image from the fixer.
